(19) United States
(12) Patent Application Publication
(10) Pub. No.: US 2022/0347685 A1
(43) Pub. Date: Nov. 3, 2022

(54) PERISTALTIC MICROPUMP DRIVEN MICROFLUIDIC PCR CHIP, THIN MEMBRANE MICROPUMP DRIVEN MICROFLUIDIC PCR CHIP

(71) Applicant: Nikon Corporation, Tokyo (JP)

(72) Inventors: Wan Qin, Oro Valley, AZ (US); Fardad Ali Hashemi, Menlo Park, CA (US)

(73) Assignee: Nikon Corporation, Tokyo (JP)

(21) Appl. No.: 17/661,733

(22) Filed: May 2, 2022

Related U.S. Application Data
(60) Provisional application No. 63/182,614, filed on Apr. 30, 2021.

(51) Int. Cl. B01L 3/00

(52) U.S. Cl. CPC B01L 3/502738; B01L 3/50273; B01L 2300/0816; B01L 2300/0867; B01L 2300/18

(57) ABSTRACT

Microchannels include membranes operable with magnets or other actuators to deliver samples to one or more reaction zones defined in the microchannels. Membrane flexing can direct samples to selected reaction zones and each reaction zone can be independently temperature controlled to implement a PCR-based sample analysis.

### CROSS REFERENCE TO RELATED APPLICATION

This application claims the benefit of U.S. Provisional Patent Application No. 63/182,614, filed on Apr. 30, 2021, which is incorporated herein by reference in its entirety.

### FIELD

The disclosure pertains to microfluidic channels configured to implement PCR-based analyses.

### BACKGROUND

Many important analyses in biology, chemistry, medicine and other fields are difficult and time consuming to perform, require bulky, expensive equipment, large sample sizes, and skilled technicians. For example, analyses based on the polymerase change reaction (PCR) require repeated temperature cycling of samples. This repeated sampling can be time consuming due to the importance of establishing the multiple temperatures and the need for numerous cycles, especially for large sample volumes and applications that require a large number of cycles.

### SUMMARY

Apparatus comprise a microfluidic channel defined in a substrate and a pump situated along the microchannel. The pump includes a flexible membrane situated along a portion of the microfluidic channel and operably coupled to the microfluidic channel to induce fluid flow in the microfluidic channel in response to deformation of the flexible membrane. A roller is situated to variably deform the flexible membrane in response to translation of the roller along the flexible membrane. The flexible membrane can be situated to define a portion of the microfluidic channel. The roller can be cylindrical or spherical and an actuator can be coupled to the roller to produce the translation of the roller along the flexible membrane. The flexible membrane can include a polydimethylsiloxane (PDMS) layer or layer of other silicone. A magnet can be situated to urge the roller to deform the flexible membrane. The magnet and can be an electromagnet and a current source can be coupled to the electromagnet. Typically, the roller is situated to variably deform the flexible membrane to select a sample volume which can correspond to a reaction zone volume and selectively direct a fluid sample to at least one selected reaction zone of a plurality of reaction zones defined in the microfluidic channel.

In further examples, apparatus include a microfluidic channel defined in a substrate and comprising at least one reaction zone. At least one pump is situated along a portion of the microfluidic channel displaced from the at least one reaction zone, the at least one pump including a flexible membrane operably coupled to the microfluidic channel to induce fluid flow in the microfluidic channel in response to deformation of the flexible membrane, and an actuator situated to deform the flexible membrane and induce fluid flow. The flexible membrane can be situated to define a portion of the microfluidic channel and the at least one reaction zone can include a plurality of reaction zones having the same or different volumes. The pump is operable to selectively direct a sample volume in the microfluidic channel to each of the plurality of reaction zones. The at least one pump can include a plurality of pumps corresponding to the plurality of reaction zones. Each pump of the plurality of pumps can include a respective actuator and a flexible membrane, the flexible membranes extending in series along the microfluidic channel. A pump controller is operable to selectively set each of the actuators to deform the flexible membranes between disengaged and engaged positions. The at least one reaction zone can include a heating element and at least one temperature sensor that can be defined on the substrate. The substrate can include an upper substrate and a lower substrate, wherein the heating element and the temperature sensor are defined on the lower substrate. The microfluidic channel can comprise a plurality of microfluidic channels, each of the microfluidic channels defining a respective reaction zone. The least one reaction zone can comprise first, second, and third reaction zones and the pump is operable to repetitively direct a fluid sample in the microfluidic channel to the first, second, and third reaction zones, wherein each of the first, second, and third reaction zones is associated with a respective temperature. In an example, the first, second, and third reaction zones are associated with a denaturation temperature, an annealing temperature, and an extension temperature for a polymerase chain reaction, respectively.

Methods comprise defining a microchannel in at least one substrate and providing a flexible member along a selected portion of the microchannel. A roller member is situated proximate the flexible member, the roller member operable to deform the flexible member to produce fluid flow in the microchannel. The roller member can be situated to be operable to deform the flexible member to produce bidirectional fluid flow in the microchannel and to repetitively cycle a fluid sample between two or more reaction zones. A temperature sensor and a heating element can be situated at each of the two or more reaction zones. The two or more reaction zones can be situated at a common side of the selected portion of the microchannel associated with the flexible member. The substrate can comprise an upper substrate and a lower substrate, and the microchannel is defined in the upper substrate. The temperature sensor and the heating element for each of the two or more reaction zones can be are secured to the lower substrate. The flexible member can be formed of PDMS.

Methods comprise situating a fluid sample at a first end of a microchannel, and with a pump having a flexible member situated at a second end of the microchannel, directing the fluid sample to at least one reaction zone of the microchannel. The reaction zone can be spaced apart from the flexible member and the fluid sample is directed to the reaction zone by deforming the flexible member. The flexible member can be deformed with a cylinder or sphere that is operable to roll along the flexible member. The temperature at the reaction zone can be established with a temperature sensor and a heating element secured to a substrate in which the microchannel is defined. The flexible member is deformed by contacting the flexible member with pressure element and urging the pressure element along an axis perpendicular to a microchannel flow axis. The microchannel defines a plurality of reaction zones and the fluid sample is directed to a selected reaction zone of the plurality of reaction zones. In some examples, the fluid sample is directed cyclically to each of the reaction zones. In some examples, respective temperatures at the first, second, and third reaction zones are established with respective temperature sensors and heating elements secured to a substrate in which the microchannel is defined. In one example, the first, second, and third reaction zones are associated with a denaturation temperature, an annealing temperature, and an extension temperature for a polymerase chain reaction.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 illustrates a representative microchannel reactor.

FIGS. 2A-2B illustrate a representative microchannel pump that includes a flexible membrane.

FIGS. 2C-2D illustrate additional representative microchannel pumps that include a flexible membrane.

FIG. 3 illustrates a representative microchannel reactor that include three reaction zones and a membrane peristaltic pump.

FIG. 4A illustrates a representative microchannel reactor that includes three reaction zones and a magnetically operated membrane pump.

FIGS. 4B-4E illustrate operation of the microchannel reactor of FIG. 4A.

FIG. 4F illustrates a microchannel reactor having reaction zones that are associated with differing volumes.

FIG. 5A illustrates a representative analysis system that includes multiple membrane valves.

FIG. 5B illustrates a representative system with fluid sensors and further illustrating reciprocal flow.

FIG. 6 illustrates a representative method of analysis using a microchannel reactor that includes a membrane pump.

FIG. 7 illustrates an array of microchannel reactors defined in one or more common substrate layers.

FIG. 8 illustrates a representative method of making a microchannel reactor.

### DETAILED DESCRIPTION

### Terminology and General Considerations

As used herein, “microfluidic channel” or “microchannel” refers to a fluid conduit having circular, elliptical, arcuate, polygonal, rectangular, square, or other cross section of area less than 0.01, 0.1, 1, 2, 5, or 10 mm². “Reaction zone” or “zone” refers to a region of a microfluidic channel that is configurable for execution of a particular chemical or biological analytical or other process. Reaction zones include a reaction volume defined in a microfluidic channel. Typical reaction zone volumes are between 1 nL and 1 μL, 10 nL and 500 nL, or 20 nL and 1 μL and reaction zone lengths are typically between about 100 μm and 20 mm. In addition, reaction zones can include one or more control elements operable to establish appropriate parameters for the samples in the reaction volume. For example, one or more temperature sensors can be provided along with one or more heating elements or cooling elements, such as, for example, thermoelectric coolers, resistors, or other heating or cooling devices. In some cases, these and other parameters in the reaction volume can be controlled with elements disposed on or at a substrate in which the reaction volume is defined. In some cases, one or more ports of a microfluidic channel are referred to as inputs or outputs for convenience. However, in typical applications, the choice of a particular port for input or output is arbitrary and for the purposes of this disclosure, such usage is merely for convenient description unless the context requires otherwise. In addition, in some cases fluid flow is referred to as in or from a downstream or upstream direction. Such terms are used to describe fluid flow that progresses in a single direction from an input to an output for processing. In some cases, fluid samples can be directed in both upstream and downstream directions for repeated or nonsequential access to one or more reaction volumes, including periodic, reciprocating, cyclic movement of a sample among reaction volumes. As used herein, “substrate” can refer to a single material or multiple materials that are secured together. In some cases, two or more wafers, layers, or sheets of the same or different materials are used. Representative materials include but are not limited to glass, fused silica, and plastics.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items unless the context requires otherwise. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present, or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus are referred to as “lowest”, “best”, “minimum,” or the like. It will be appreciated that such descriptions are intended to indicate that a selection among many used functional alternatives can be made, and such selections need not be better, smaller, or otherwise preferable to other selections. Examples are described with reference to directions indicated as “above,” “below,” “upper,” “lower,” and the like. These terms are used for convenient description, but do not imply any particular spatial orientation.

In the examples, particular arrangements of pumps, microchannels, input ports, and sensors are shown for convenient illustration. Pumps are shown as ends of microchannels but can be situated at intermediate locations or an arbitrary location along a microchannel. End pumping permits reciprocal access to reaction volumes upstream and downstream of a pump. In some examples, flow is bidirectional. Microchannels are illustrated as linear but can be curved, serpentine or a combination of linear and/or curved sections. In some cases, reaction zones can be defined in linear, curved, serpentine or microchannel shapes and can have the same or different lengths, widths, and cross-sectional areas. Pumps, flow sensors, and thermal sensors and heaters/coolers can be coupled to dedicated circuitry that can provide closed-loop flow and thermal control. Control can be provided with a processor system such as a microcontroller, embedded controller, an FPGA or CPLD, or other such device that can be provided with memory such as RAM or ROM that stores controller-executable instructions for performing any of the methods disclosed herein and to serve as controllers for any of the disclosed systems and devices. In addition, one or more analog-to-digital converters (ADCs) and digital-to-analog converters (DACs) can be coupled to thermal sensors, flow sensors, and heaters/coolers to interface with the controller.

### Example 1. Representative Microchannel Assembly

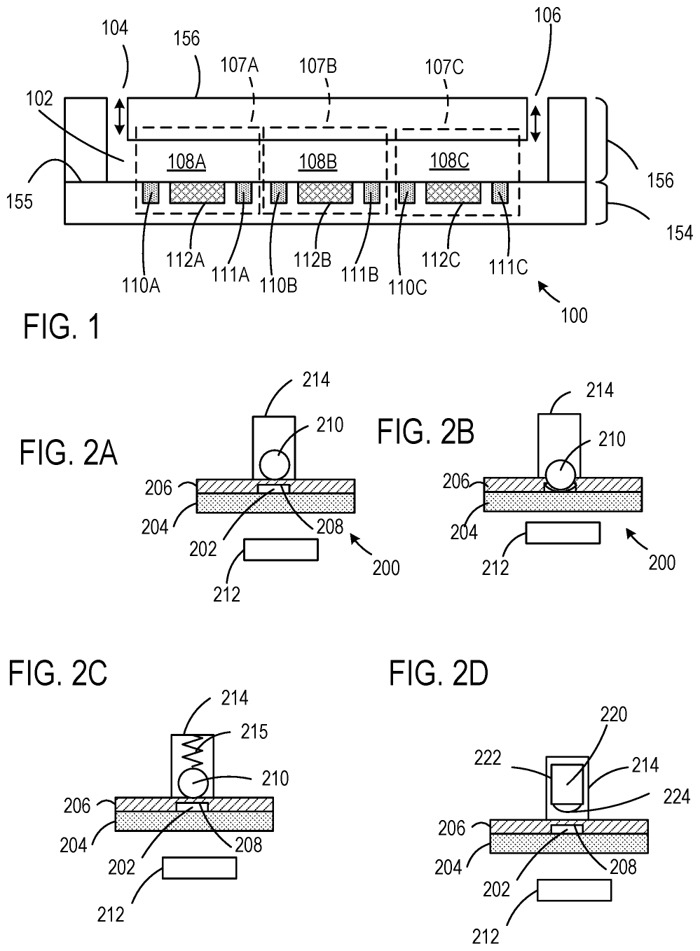

Referring to FIG. 1A, microchannel reactor 100 comprises a top substrate 156 and a bottom substrate 154 that are bounded with an adhesive, sealant, or other layer 155. The top substrate 156 is patterned to define a microchannel 102 and a first port 104 and a second port 106. Other constructions are possible but in the example of FIG. 1A, channels and ports are defined in a single substrate (the top substrate 156) that is sealed with another substrate (the bottom substrate 154) Reaction zones 107A-107C are defined in the microchannel reactor 100 and include respective zone volumes 108A-108C, thermal sensors 110A-110C, 111A-111C, and heating elements 112A-112C. In the example of FIG. 1, three reaction zones are defined, but fewer or more can be provided. The ports 104, 106 can be coupled to receive a sample or reagents used for sample processing or evaluation, to a pump to produce flow in the microchannel 102, or to additional processing volumes in other microchannels or other processing volumes, or to analysis instrumentation such as spectrometers, fluorometers, chromatography, or other measurement apparatus.

### Example 2. Representative Membrane Magnetic Pumps

While flow in a microchannel can be provided with conventional pumps, pumps that can be integral with microchannel substrates and/or made compact are desirable. Referring to FIGS. 2A-2B, a representative microchannel pump 200 includes a microchannel 202 defined by a first substrate 204 and a second substrate 206. The second substrate 206 can be formed of a flexible material and as shown, includes a thinned region 208 that both defines the microchannel 202 and provides increased flexibility. A first magnetic element 210 is situated proximate the thinned region 208 and a second magnetic element 212 is situated opposite the first magnetic element 210. The first magnetic element 210 can be restrained by a sleeve 214 so to remain situated at the thinned region 208. As shown in FIG. 2B, the second magnetic element 212 can be moved towards the first substrate 204 so that the first magnetic element 210 is magnetically urged into the thinned region 208 to deflect the thinned region 208 toward the first substrate 204 and produce fluid flow in the microchannel 202. In some examples, first magnetic element 210 is a spherical, cylindrical or other shape of steel or other magnetic material and the second magnetic element 21 is a rare earth magnet. In additional examples, the first magnetic element 210 is a spherical, cylindrical or other shape rare earth or other magnet and the second magnetic element 212 is made a magnetic material or is a magnet. In still other examples, the first magnetic element 210 and the second magnetic element 212 are rare earth or other magnets. In additional examples, an electromagnet is used instead of or in addition to a permanent magnet material and can be electrically switched to urge the first magnetic element 210 to produce flow.

Referring to FIG. 2C, a spring 215 or other compressive member such as a spring washer can be situated to urge the first magnetic member 210 into the thinned zone 208. In one example, first magnetic element 210 and the second magnetic element 212 are rare earth or other magnets situated so that the first magnetic element 210 is urged away from the thinned region 208 by the second magnetic element 212. In this case, without the second magnetic element 212, the thinned region 208 is compressed toward the first substrate 204. In another example, the first magnetic element 210 and the second magnetic element 212 are rare earth or other magnets situated so that the first magnetic element 210 is urged toward the thinned region 208 by the second magnetic element 212. Electromagnets can be used instead or in addition to permanent magnets. In an example shown in FIG. 2D, the thinned region 208 is flexed with a pushing member 220 that includes a magnetic portion 222 (made of a magnet or magnetic material) and a contact portion 224 that can be magnetic or non-magnetic.

### Example 3. Representative Microchannel with Extended Membrane Pump

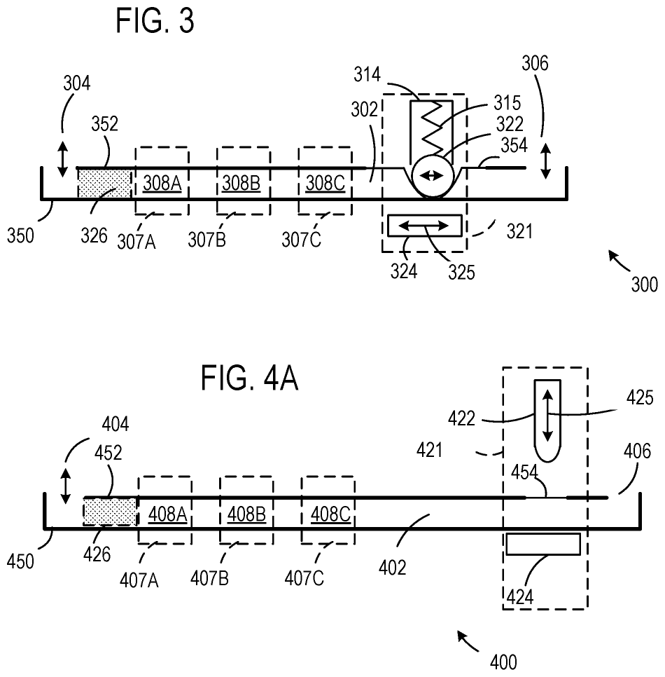

Referring to FIG. 3, microchannel reactor 300 includes a microchannel 302 that terminates at a first port 304 and a second port 306 and is defined by a first substrate 350, a second substrate 352, and a flexible layer 354. Reaction zones 307A-307C are defined in the microchannel 302 and include respective zone volumes 308A-308C (typically having the same volume but can have different volumes) and one or more thermal sensors, heating elements, thermoelectric coolers or other temperature control and sensing elements such as shown in FIG. 1. In the example of FIG. 3, three reaction zones are defined, but fewer or more can be provided.

Fluid flow is produced in the microchannel 302 with a magnetic membrane pump 321 that includes first and second magnetic elements 322, 324 and a portion of the flexible layer 354. The second magnetic element 324 can be translated along an axis 325 to produce a corresponding translation of the first magnetic element 322 thereby producing fluid flow, acting as a microchannel peristaltic pump. In some examples, flow is adjusted so that a sample 326 having a volume corresponding the zone volumes 308A-308C can be shuttled among the reaction zones 307A-307C. However, sample volumes can be smaller or larger than one or all of the zone volumes. In some cases, only a portion of a sample volume is temperature controlled, heated, cooled, or otherwise temperature cycled. In addition, the pump 321 includes a spring 315 or other member that retains the first magnetic member 322 in a cylinder 314. The second magnetic element 324 can be operable to urge the first magnetic element 322 toward the substrate 350 as well as produce a translation of the first magnetic element 322. The sample 326 is shown proximate the port 304 but can be introduced and/or expelled at either the first port 304 or the second port 306. As noted above, various combinations of magnetic materials, permanent magnets, and electromagnets can be used as convenient. The second magnetic element 324 can comprise a plurality of switchable magnets to produce translation of the first magnetic element. Alternatively, the second magnetic element 324 can be coupled to an actuator that produces motion along the axis 325 and is operable to move the second magnetic element toward the first magnetic element 302 to cause the first magnetic element 322 to engage the flexible layer 354.

### Example 4. Representative Microchannel with Single Axis Membrane Pump

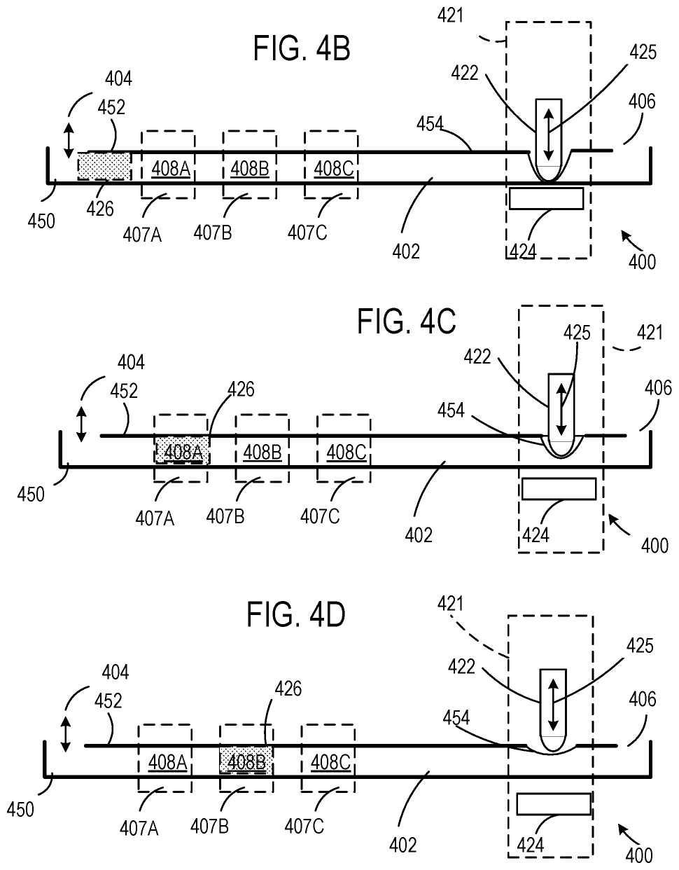

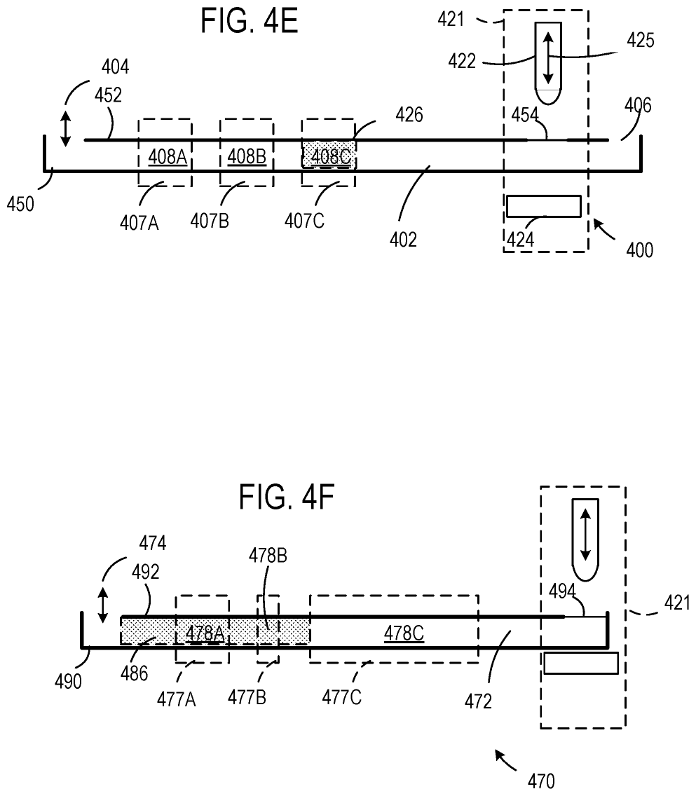

Referring to FIG. 4A, microchannel assembly 400 includes a microchannel 402 defined by a first substrate 450, a second substrate 452, and a flexible layer 454. As shown, the microchannel 402 includes a first port 404 that is coupled to receive a sample 426 having a selected sample volume. One or more additional ports such as a second port 406 are generally provided along the microchannel 402. Reaction zones 407A-407C are defined in the microchannel assembly 400 and include respective zone volumes 408A-408C (typically having the same volume) and one or more thermal sensors, heating elements, thermoelectric coolers or other temperature control and sensing elements such as shown in FIG. 1. In the example of FIG. 4A, three reaction zones are defined, but fewer or more can be provided. In some cases, zone volumes can be different. Such different volumes could permit constant pump/shuttling speed but with different dwell time in each zone or at each temperature.

Fluid flow is produced in the microchannel 402 with a magnetic membrane pump 421 that includes first and second magnetic elements 422, 424 and a portion of the flexible layer 454. The second magnetic element 424 can be translated toward or away from the microchannel 402 to produce fluid flow. Typically, flow is adjusted so that a sample 426 having a volume corresponding the zone volumes 408A-408C can be shuttled among the reaction zones 407A-407C. As noted above, various combinations of magnetic materials, permanent magnets, and electromagnets can be used as convenient. The second magnetic element 424 can be coupled to an actuator that is operable to move the second magnetic element 424 toward the first magnetic element 402 to cause the first magnetic element 422 to variably engage the flexible layer 454 to situate the sample 426 in a selected reaction zone.

FIGS. 4B-4E illustrate operation of the microchannel assembly 400. In FIG. 4B, the first magnetic element 422 can be fully engaged to displace a maximum or other volume of the microchannel 402 with the flexible layer 454. As shown, the sample 426 is situated near the port 404 and outside of the reaction zones 407A-407C. In FIG. 4C, the first magnetic element 422 is engaged to a first intermediate position with a first intermediate deformation of the flexible layer 424 so that the sample 426 is moved into the reaction volume 408A. In FIG. 4D, the first magnetic element 422 is engaged to a second intermediate position with a second intermediate deformation of the flexible layer 424 so that the sample 426 is moved into the reaction volume 408B. In FIG. 4E, the first magnetic element 422 is minimally engaged with a minimal deformation (or no deformation) of the flexible layer 424 so that the sample 426 is moved into the reaction volume 408C. By selecting a suitable deformation of the flexible layer 454, the sample 426 can be directed into any of the reaction volumes 407A-407C and such direction can be repetitive as may be desired.

The magnetic membrane pump 421 is operable in these examples so that the flexible layer 454 is flexed into the microchannel 402 but the first magnetic element 422 can be secured to the flexible layer so that the flexible layer 454 can be flexed in a direction opposite the microchannel 402. Particular compression or extension of the flexible layer 454 can be selected to provide the desired movement of the sample in the microchannel 402 including to expel the sample 426 from the microchannel 402.

Referring to FIG. 4F, microchannel assembly 470 includes a microchannel 472 defined by a first substrate 490, a second substrate 492, and a flexible layer 494. As shown, the microchannel 472 includes at least a first port 474. The microchannel 472 is coupled to receive a sample 486 having a selected sample volume from the port 474. Reaction zones 477A-477C are defined in the microchannel assembly 470 and include respective zone volumes 478A-478C and one or more thermal sensors, heating elements, thermoelectric coolers or other temperature control and sensing elements such as shown in FIG. 1. In the example of FIG. 4A, three reaction zones are defined, each having a different length along the microchannel 472, but fewer or more can be provided. In some cases, a cross-section of the microchannel 472 varies along its length so that zones of different lengths can have the same (or different) volumes. Such different volumes could permit constant pump/shuttling speed but with different dwell time in each zone or at each temperature. Fluid flow can be produced in the microchannel 472 with a magnetic membrane pump 421 as shown in FIGS. 4B-4E.

### Example 5. Representative Microchannel with Multiple Membrane Pump

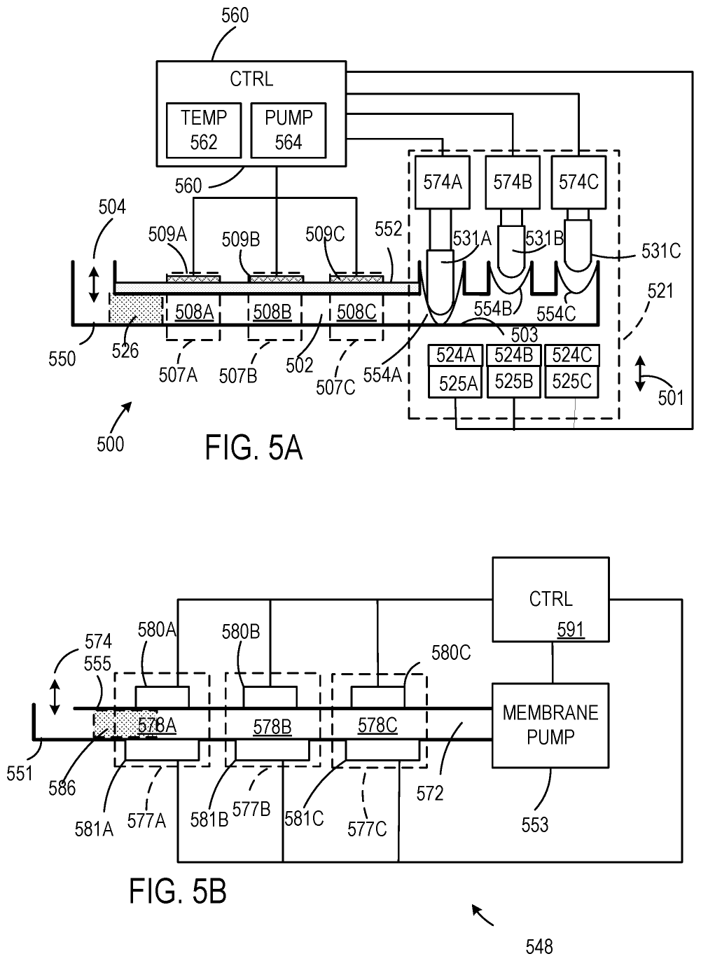

Referring to FIG. 5A, microchannel system 500 includes a microchannel 502 defined by a first substrate 550, a second substrate 552, and flexible layers 554A-554C. As shown, the microchannel 502 includes a port 504 that is coupled to receive a sample 526 having a selected sample volume. Reaction zones 507A-507C are defined in the microchannel assembly 500 and include respective zone volumes 508A-508C (typically having the same volume) and one or more thermal sensors, heating elements, thermoelectric coolers or other temperature control and sensing elements 509A-509C. Three reaction zones are defined, but fewer or more can be provided.

Fluid flow is produced in the microchannel 502 with a membrane pump 521 that can include first magnetic elements 531A-531C (referred to also as pushing elements), second magnetic elements 524A-524C and the flexible layers 554A-554C that comprise first, second and third pump elements, respectively. Any of the magnetic elements can include non-magnetic portions as discussed above and, in some examples, mechanical actuators can be used instead of or in addition to magnets. The second magnetic elements 524A-524C can be translated toward or away from the microchannel 502 in a direction 501 to produce fluid flow. Typically, flow is adjusted so that a sample 526 having a volume corresponding the zone volumes 508A-508C can be shuttled among the reaction zones 507A-507C, but other sample volumes can be used. As noted above, various combinations of magnetic materials, permanent magnets, and electromagnets can be used as convenient. The second magnetic elements 524A-524C can be coupled to respective actuator 525A-525C that are operable to move the second magnetic elements 524A-524C toward the microchannel 502 to cause the first magnetic elements 531A-531C to variably engage the flexible layers 554A-554C to situate the sample 526 in a selected reaction zone. In an alternative configuration, magnetic elements need not be used (but can be). In this case, the first magnetic elements 531A-531C are pushing members coupled to respective linear actuators 574A-574C that are operable to selectively deform a respective flexible membrane 554A-554C.

A control system 560 includes a temperature controller 562 coupled to the temperature control and sensing elements 509A-509C and a pump controller 564 that is coupled to actuators such as the actuators 525A-525C or the actuators 524A-524C or both as needed.

In some examples, the first, second, and third pump elements are controlled to produce a variable range of fluid displacements associated with a variable range of flexible member deformations. Such operation can be referred to as analog operation. In another alternative, one or more or all of the first, second, and third pump elements are controlled to be either fully engaged, i.e., the first magnetic elements 531A-531C are fully extended into the microchannel 502, or fully withdrawn from the microchannel 502. Such operation can be referred to as binary or digital and tends to reduce flow volume errors associated with changes in flexible layers or other components. However, with digital operation, pump elements that are situated on the sample side of other pump elements may need to be in a withdrawn (or partially withdrawn) state as other pump elements are engaged. For example, if the first pump element is fully engaged with the first magnetic element 531A deforming the flexible membrane 554A against a wall 503 of the microchannel 502, fluid communication of the second pump element and the third pump element with the microchannel 502 can be cut off.

A representative arrangement of pump element settings for moving the sample to a selected reaction zone is provided in the following table. Other arrangements are possible, particularly if the pump elements do not block the microchannel 502 when fully engaged. The pump volume provided by some or all of the pump elements can be different although the pump volumes are generally selected so that samples can be introduced and repetitively cycled into and out of the reaction zones. The first pump element (associated with pushing member 531A) can be operable to displace a different volume as the necessary volume can be based on a volume of the microchannel 502 from the port 504 to the first reaction zone 508A.

Sample Position and Pump Condition (Digital Operation)

| sample | first pump | second pump | third pump |
|---|---|---|---|
| location | element | element | element |
| loading | engaged | engaged | engaged |
| first reaction | disengaged | engaged | engaged |
| zone | | | |
| second | disengaged | disengaged | engaged |
| reaction zone | | | |
| third reaction | disengaged | disengaged | disengaged |
| zone | | | |

### Example 6. Representative System with Fluid Sensors and Reciprocal Flow

Referring to FIG. 5B, microchannel system 548 includes a microchannel 572 defined by a first substrate 551 and a second substrate 555. A membrane pump 553 such as any of the membrane pumps disclosed herein or other pumps can be coupled to the microchannel 572 and is operable to produce fluid flow in the microchannel 572. As shown, the microchannel 572 includes at least a first port 574. The microchannel 572 is coupled to receive a sample 586 having a selected sample volume from the port 574. Reaction zones 577A-577C include respective zone volumes 578A-578C and one corresponding thermal control elements 581A-581C such as thermal sensors, heating elements, thermoelectric coolers or other temperature control and sensing. In addition, corresponding fluid sensors 580A-580C can be configured to sense fluid presence in the respective zone volumes. Such fluid sensors can be optical sensors, acoustic sensors, vibrational sensors, capacitive or resistive sensors, or others. The thermal control elements 581A-581C are coupled to a controller 591 that controls reaction zone temperature using heating or cooling elements and thermal sensors situated at the reaction zones 577A-577C. The fluid sensors 580A-580C are also coupled to the controller 591 that regulates the membrane pump 553 to direct the sample to a selected zone volume. Fluid sensors are shown at each of the reaction zones 577A-577C, fewer fluid sensors can be used, and one or more fluid sensors can be situated at other locations along the microchannel 572, including between the reaction zones 577A-577C. As noted in other examples, fluid sensors are not required but may aid in pump operation and can avoid a need for pump calibration.

In the example of FIG. 5B three reaction zones are defined and the membrane pump 553 is operable to shuttle one or more samples among the reaction zones with back and forth motion along the microchannel 572 in directions toward and away from the input port 572. Pumping that is operable to produce bi-directional motion in a microchannel is referred to herein as “reciprocal” pumping. In the example of FIG. 5B, pumping can be reciprocal and periodic such that a selected sample is moved back and forth among the reaction zones 578A-578C and is situated at one or all of the reaction zones 578A-578C in a periodic sequence. Such pumping can be particularly useful in multistage processes in which multiple exposures in each reaction zone are desired.

### Example 7. Representative Microchannel and Membrane Pump Operation

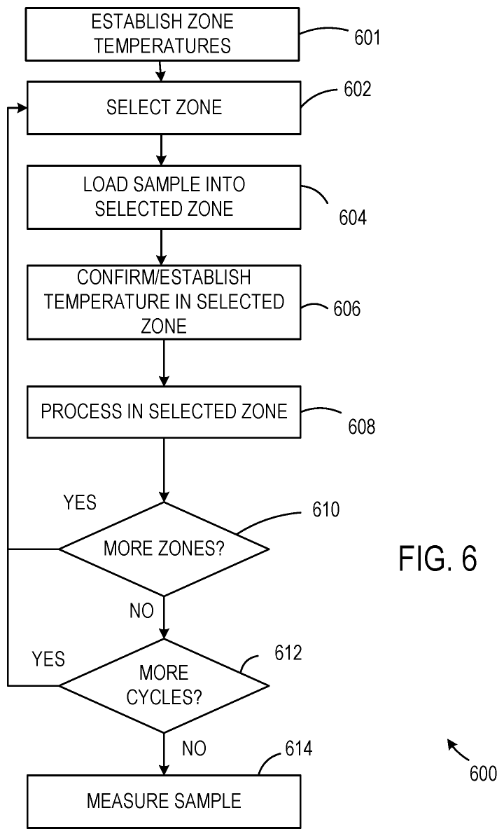

Referring to FIG. 6, a method 600 of operation of a microchannel reactor using a membrane or other pump includes establishing suitable processing temperatures in one or more zones of a microchannel at 601. In some cases, temperatures can be established as a sample is received, particularly since microchannel-based reaction zones can be rapidly controlled to process temperatures. A reaction zone is selected at 602 and a sample is loaded into the selected reaction zone at 604 by altering a shape of a flexible membrane that partially defines the microchannel. At 606, a suitable temperature of the sample is confirmed, controlled, or established in the reaction zone and at 608, the sample is processed in the selected reaction zone at the established temperature. In some examples, processing comprises holding the sample at the established temperature for a suitable time. At 610, it is determined if the sample is to be directed to additional zones. If so, processing returns to 602 for selection of a zone. If no additional zones are to be selected, at 612 it is determined if the sample should be directed to the zones again in another processing cycle. If so, processing returns to 602. Once all processing cycles are complete, at 614 the processed sample is measured or delivered for use in other processes.

In one example, the method 600 and apparatus such as illustrated above are used to implement a polymerase chain reaction (PCR) such as a PCR-based test for viruses such as corona viruses. In a PCR test, the sample is cyclically directed to a reaction zone for denaturing at a temperature of about 94-96 C. a reaction zone for annealing at a temperature of about 50-68 C, and a reaction zone for elongation at a temperature of about 72 C. Reaction zones can be controlled to be at suitable PCR zone temperatures and the sample shuttled between these zones and held in the zones as required. With the microchannel reactors disclosed above, multiple cycles can be realized using small sample volumes.

Reaction zone temperatures, sample dwell or transit time through some or all zones, and numbers of cycles in the zones can be selected for analyses and reactions other than PCR. Fewer or more zones can be provided, and any zone can be heated or cooled based on the process to be implemented.

### Example 8. Representative Multiple Microchannel Reactor

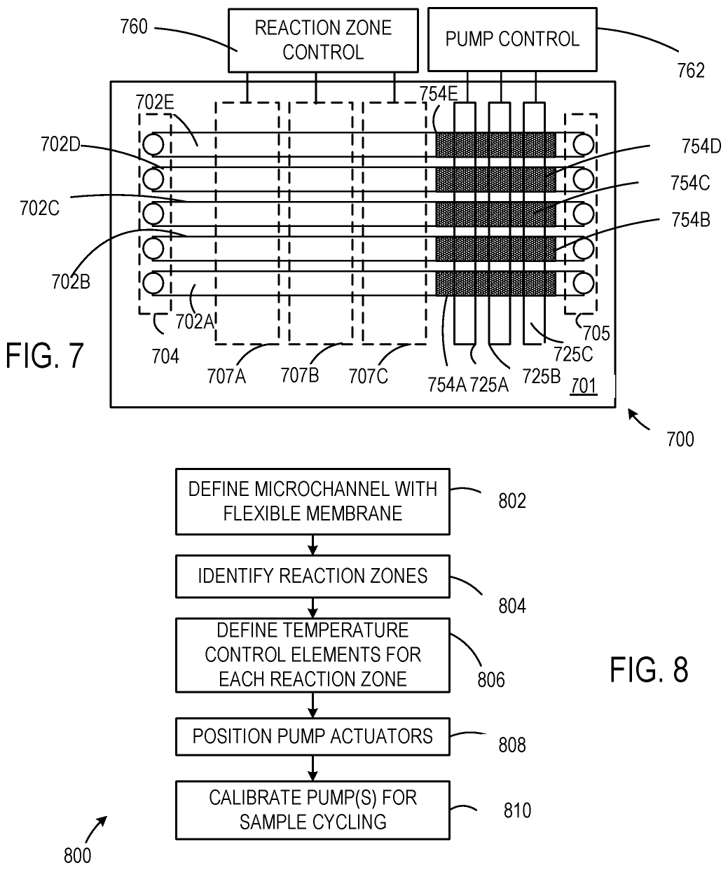

FIG. 7 illustrates a microchannel system 700 that includes a plurality of microchannels 702A-702E defined in a substrate 701. Reaction zones 707A-707C are defined and include respective zone volumes and temperature control and measurement elements associated with each of the microchannels 702A-702E. The reaction zone portions associated with each of the microchannels 702A-702E can be operated in the same or different manner as preferred. Respective membrane regions 754A-754E can be operated with magnetic or other actuators 725A-725C to serve as pumps, and reaction zone volumes in each of the microchannels 702A-702E can be independently operated or some or all can be operated together to, for example, process respective samples in the same manner. Input/output zones 704, 705 include input/output ports for the microchannels 702A-702E. Reaction zone temperatures are controlled with control electronics 760 and pumping is controlled with a pump controller 762 that is coupled to the magnetic or other actuators 725A-725C. Reaction zone temperatures can be controlled with the control electronics 760 based on the information obtained by at least one temperature sensor that can be defined on the substrate. The controllers 760, 762 can be provided in a common control system that can establish suitable conditions for reactions and control shuttling of samples back and for the in the microchannels 702A-702E as needed. At least one fluid sample sensor can be defined on the substrate and pumping controlled with a pump controller 762 based on the information obtained by the fluid sample sensor. The at least one reaction zone can include at least one fluid sample sensor that can be defined on the substrate and pumping is controlled with a pump controller 762 based on the information obtained by the fluid sample sensor.

In one example, the microchannel system 700 can be used to process respective samples in each of the microchannels 702A-702E in parallel, with the reactions zones 707A-707C controlled to suitable temperatures for polymerase chain reaction (PCR) analysis. The reaction zones 707A-707E are then set for denaturing, annealing, and elongation processes, and many PCR cycles can be achieved with the sample directed to the reaction zones cyclically by the pump control 762. In the example of FIG. 7, five microchannels are provided but fewer or more can be provided.

### Example 9. Representative Microchannel Fabrication

Referring to FIG. 8, a method 800 of fabricating a microchannel system includes defining a microchannel with a flexible membrane portion at 802. At 804, one or more reaction zones are identified, and at 806, temperature control elements such as heaters, thermoelectric devices, and temperature sensors are provided for the reaction zones. Temperature control elements can be formed directly on a microchannel substrate by, for example, deposition of suitable films, or can be provided as discrete parts that are secured to a microchannel substrate. At 808, pump actuators are situated at the flexible membrane and at 810, the pump actuators are energized so that pump volumes as a function of pump actuator positions or pump actuator electrical drive can be calibrated.

### REPRESENTATIVE EMBODIMENTS

Embodiment 1 is an apparatus, including: a microfluidic channel defined in a substrate; and a pump that includes: a flexible membrane situated along a portion of the microfluidic channel and operably coupled to the microfluidic channel to induce fluid flow in the microfluidic channel in response to deformation of the flexible membrane, and a roller situated to variably deform the flexible membrane in response to translation of the roller along the flexible membrane.

Embodiment 2 includes the subject matter of Embodiment 1, and further specifies that the flexible membrane is situated to define a portion of the microfluidic channel.

Embodiment 3 includes the subject matter of any of Embodiments 1-2, and further specifies that the roller is cylindrical.

Embodiment 4 includes the subject matter of any of Embodiments 1-3, and further specifies that the roller is spherical.

Embodiment 5 includes the subject matter of any of Embodiments 1-4, and further includes an actuator coupled to the roller to produce the translation of the roller along the flexible membrane.

Embodiment 6 includes the subject matter of any of Embodiments 1-5, and further specifies that the flexible membrane includes a PDMS layer.

Embodiment 7 includes the subject matter of any of Embodiments 1-6, and further includes a magnet situated to urge the roller to deform the flexible membrane.

Embodiment 8 includes the subject matter of any of Embodiments 1-7, and further specifies that the magnet is an electromagnet, and further includes a current source coupled to the electromagnet.

Embodiment 9 includes the subject matter of any of Embodiments 7, and further specifies that the roller is situated to variably deform the flexible membrane to select a sample volume corresponding to a reaction zone volume and selectively direct a fluid sample to a selected reaction zone of a plurality of reaction zones defined in the microfluidic channel.

Embodiment 10 includes the subject matter of any of Embodiments 1-9, and further specifies that the roller is situated to variably deform the flexible membrane to select a sample volume corresponding to a reaction zone volume and selectively direct a fluid sample to a selected reaction zone of a plurality of reaction zones defined in the microfluidic channel, wherein the reaction zones are situated along the microfluidic channel between an input port and the flexible membrane.

Embodiment 11 includes the subject matter of any of Embodiments 1-10, and further includes a controller coupled to the roller to shuttle the sample volume bidirectionally among the reaction zones.

Embodiment 12 is an apparatus, including: a microfluidic channel defined in at least one substrate and comprising at least one reaction zone; and at least one pump situated along a portion of the microfluidic channel displaced from the at least one reaction zone, the at least one pump including: a flexible membrane operably coupled to the microfluidic channel to induce fluid flow in the microfluidic channel in response to deformation of the flexible membrane, and an actuator situated to deform the flexible membrane and induce fluid flow.

Embodiment 13 includes the subject matter of Embodiment 12, and further specifies that the flexible membrane is situated to define a portion of the microfluidic channel.

Embodiment 14 includes the subject matter of any of Embodiments 12-13, and further specifies that the at least one reaction zone includes a plurality of reaction zones and the pump is operable to selectively direct a sample in the microfluidic channel to each of the plurality of reaction zones.

Embodiment 15 includes the subject matter of any of Embodiments 12-14, and further specifies that the at least one pump includes a plurality of pumps corresponding to the plurality of reaction zones.

Embodiment 16 includes the subject matter of any of Embodiments 12-15, and further specifies that each pump of includes a respective actuator and a respective flexible membrane, each respective flexible membrane extending in series along the microfluidic channel.

Embodiment 17 includes the subject matter of any of Embodiments 12-16, and further includes a pump controller operable to selectively set each of the respective actuators to deform the respective flexible membrane between disengaged and engaged positions.

Embodiment 18 includes the subject matter of any of Embodiments 12-17, where the at least one reaction zone comprises a heating element and at least one temperature sensor.

Embodiment 19 includes the subject matter of any of Embodiments 12-18, and further specifies that the heating element and the temperature sensor are defined on the substrate.

Embodiment 20 includes the subject matter of any of Embodiments 12-19, and further specifies that the substrate includes an upper substrate and a lower substrate, and the heating element and the temperature sensor are defined on the lower substrate.

Embodiment 21 includes the subject matter of any of Embodiments 12-20, and further specifies that the microfluidic channel comprises a plurality of microfluidic channels, each of the plurality of microfluidic channels defining the at least one reaction zone.

Embodiment 22 includes the subject matter of any of Embodiments 12-21, and further specifies that the at least one reaction zone comprises first, second, and third reaction zones and the pump is operable to repetitively direct a fluid sample in the microfluidic channel to the first, second, and third reaction zones, wherein each of the first, second, and third reaction zones is associated with a respective temperature.

Embodiment 23 includes the subject matter of any of Embodiments 12-22, and further specifies that the first, second, and third reaction zones are associated with a denaturation temperature, an annealing temperature, and an extension temperature for a polymerase chain reaction.

Embodiment 24 includes the subject matter of any of Embodiments 12-23, and further specifies that the first, second, and third reaction zones are distributed sequentially along the microfluidic channel from an input port of the microfluidic channel, and the pump is operable to repetitively direct a sample in the microfluidic channel toward the input port or away from the input port.

Embodiment 25 includes the subject matter of any of Embodiments 12-24, and further includes; a fluid sensor operable to produce a signal indicative of a position of a liquid in the microfluidic channel; and a controller coupled to the fluid sensor and operable to cause the pump to repetitively direct a liquid sample to the first, second, and third reaction zones.

Embodiment 26 includes the subject matter of any of Embodiments 12-25, and further includes; a fluid sensor operable to produce a signal indicative of a position of a liquid in the microfluidic channel; and a controller coupled to the fluid sensor and operable to cause the pump to direct a liquid sample to a selected reaction zone.

Embodiment 27 is a method, including: defining a microchannel in at least one substrate; providing a flexible member along a selected portion of the microchannel; and situating a roller member proximate the flexible member, the roller member operable to deform the flexible member to produce fluid flow in the microchannel.

Embodiment 28 includes the subject matter of Embodiment 27, and further specifies that the roller member is situated to be operable to deform the flexible member to produce bidirectional fluid flow in the microchannel.

Embodiment 29 includes the subject matter of any of Embodiments 27-28, and further specifies that the flexible member is operable to repetitively cycle a fluid sample between two or more reaction zones.

Embodiment 30 includes the subject matter of any of Embodiments 27-29, and further includes situating a temperature sensor at each of the two or more reaction zones.

Embodiment 31 includes the subject matter of any of Embodiments 27-30, and further includes situating a heating element at each of the two or more reaction zones.

Embodiment 32 includes the subject matter of any of Embodiments 27-31, and further specifies that the two or more reaction zones are situated at a common side of the selected portion of the microchannel associated with the flexible member.

Embodiment 33 includes the subject matter of any of Embodiments 27-32, and further specifies that the substrate comprises an upper substrate and a lower substrate, and the microchannel is defined in the upper substrate.

Embodiment 34 includes the subject matter of any of Embodiments 27-33, and further includes a temperature sensor and a heating element for each of the two or more reaction zones, wherein the temperature sensor and the heating element are secured to the lower substrate.

Embodiment 35 includes the subject matter of any of Embodiments 27-34, and further specifies that the flexible member is formed of polydimethylsiloxane.

Embodiment 36 is a method, including: situating a fluid sample at a first end of a microchannel; and with a pump having a flexible member situated at a second end of the microchannel, directing the fluid sample to at least one reaction zone of the microchannel, wherein the reaction zone is spaced apart from the flexible member.

Embodiment 37 includes the subject matter of any Embodiment 36, and further specifies that the fluid sample is directed to the reaction zone by deforming the flexible member.

Embodiment 38 includes the subject matter of any of Embodiments 36-37, and further specifies that the flexible member is deformed with a cylinder or sphere that is operable to roll along the flexible member.

Embodiment 39 includes the subject matter of any of Embodiments 36-38, and further includes establishing a temperature at the reaction zone with a temperature sensor and a heating element secured to a substrate in which the microchannel is defined.

Embodiment 40 includes the subject matter of any of Embodiments 36-30, and further specifies that the flexible member is deformed by contacting the flexible member with pressure element and urging the pressure element along an axis perpendicular to a microchannel flow axis.

Embodiment 41 includes the subject matter of any of Embodiments 36-40, and further specifies that the microchannel defines a plurality of reaction zones, and further includes directing the fluid sample to a selected reaction zone of the plurality of reaction zones.

Embodiment 42 includes the subject matter of any of Embodiments 36-41, and further includes cyclically directing the fluid sample to each of the reaction zones.

Embodiment 43 includes the subject matter of any of Embodiments 36-42, and further specifies that the plurality of reaction zones consists of first, second, and third reaction zones, and further includes: establishing respective temperatures at the first, second, and third reaction zones with respective temperature sensors and heating elements secured to a substrate in which the microchannel is defined.

Embodiment 44 includes the subject matter of any of Embodiments 36-43, and further specifies that the first, second, and third reaction zones are associated with a denaturation temperature, an annealing temperature, and an extension temperature for a polymerase chain reaction.

In view of the many possible embodiments to which the principles of the disclosed technology may be applied, it should be recognized that the illustrated embodiments are only preferred examples and should not be taken as limiting the scope of the disclosure.

We claim:

1. An apparatus, comprising:
a microfluidic channel defined in a substrate; and
a pump that includes:
a flexible membrane situated along a portion of the microfluidic channel and operably coupled to the microfluidic channel to induce fluid flow in the microfluidic channel in response to deformation of the flexible membrane, and
a roller situated to variably deform the flexible membrane in response to translation of the roller along the flexible membrane.

2. The apparatus of claim 1, wherein the flexible membrane is situated to define a portion of the microfluidic channel.

3. The apparatus of claim 1, further comprising an actuator coupled to the roller to produce the translation of the roller along the flexible membrane.

4. The apparatus of claim 1, wherein the flexible membrane includes a PDMS layer.

5. The apparatus of claim 1, further comprising a magnet situated to urge the roller to deform the flexible membrane.

6. The apparatus of claim 5, wherein the magnet is an electromagnet, and further comprising a current source coupled to the electromagnet.

7. The apparatus of claim 5, wherein the roller is situated to variably deform the flexible membrane to select a sample volume corresponding to a reaction zone volume and selectively direct a fluid sample to a selected reaction zone of a plurality of reaction zones defined in the microfluidic channel.

8. The apparatus of claim 1, wherein the roller is situated to variably deform the flexible membrane to select a sample volume corresponding to a reaction zone volume and selectively direct a fluid sample to a selected reaction zone of a plurality of reaction zones defined in the microfluidic channel, wherein the reaction zones are situated along the microfluidic channel between an input port and the flexible membrane.

9. The apparatus of claim 8, further comprising a controller coupled to the roller to shuttle the sample volume bidirectionally among the reaction zones.

10. An apparatus, comprising:
a microfluidic channel defined in at least one substrate and comprising at least one reaction zone; and
at least one pump situated along a portion of the microfluidic channel displaced from the at least one reaction zone, the at least one pump including:
a flexible membrane operably coupled to the microfluidic channel to induce fluid flow in the microfluidic channel in response to deformation of the flexible membrane, and
an actuator situated to deform the flexible membrane and induce fluid flow.

11. The apparatus of claim 10, wherein the flexible membrane is situated to define a portion of the microfluidic channel.

12. The apparatus of claim 10, wherein the at least one reaction zone includes a plurality of reaction zones and the pump is operable to selectively direct a sample in the microfluidic channel to each of the plurality of reaction zones.

13. The apparatus of claim 12, wherein the at least one pump includes a plurality of pumps corresponding to the plurality of reaction zones.

14. The apparatus of claim 13, wherein each pump of includes a respective actuator and a respective flexible membrane, each respective flexible membrane extending in series along the microfluidic channel.

15. The apparatus of claim 14, further comprising a pump controller operable to selectively set each of the respective actuators to deform the respective flexible membrane between disengaged and engaged positions.

16. The apparatus of claim 10, where the at least one reaction zone comprises a heating element and at least one temperature sensor, wherein the heating element and the temperature sensor are defined on the substrate.

17. The apparatus of claim 16, wherein the substrate includes an upper substrate and a lower substrate, and the heating element and the temperature sensor are defined on the lower substrate.

18. The apparatus of claim 10, wherein the microfluidic channel comprises a plurality of microfluidic channels, each of the plurality of microfluidic channels defining the at least one reaction zone.

19. The apparatus of claim 10, wherein the at least one reaction zone comprises first, second, and third reaction zones and the pump is operable to repetitively direct a fluid sample in the microfluidic channel to the first, second, and third reaction zones, wherein the first reaction zone is associated with a denaturation temperature, the second reaction zone is associated with an annealing temperature, and the third reaction zone is associated with an extension temperature for a polymerase chain reaction, respectively.

20. The apparatus of claim 19, wherein the first, second, and third reaction zones are distributed sequentially along the microfluidic channel from an input port of the microfluidic channel, and the pump is operable to repetitively direct a sample in the microfluidic channel toward the input port or away from the input port.

21. The apparatus of claim 20, further comprising;
a fluid sensor operable to produce a signal indicative of a position of a liquid in the microfluidic channel; and
a controller coupled to the fluid sensor and operable to cause the pump to repetitively direct a liquid sample to the first, second, and third reaction zones.

22. The apparatus of claim 10, further comprising;
a fluid sensor operable to produce a signal indicative of a position of a liquid in the microfluidic channel; and
a controller coupled to the fluid sensor and operable to cause the pump to direct a liquid sample to a selected reaction zone.
